(19) United States
(12) Patent Application Publication
(10) Pub. No.: US 2005/0065049 A1
(43) Pub. Date: Mar. 24, 2005

(54) Chemical composition for use with group IIA metal fluorides

(76) Inventors: Ronald A. Burdo, Corning, NY (US); Ronald B. Feldman, Cameron Mills, NY (US); Shaole Wu, Painted Post, NY (US)

Correspondence Address: CORNING INCORPORATED, SP-TI-3-1, CORNING, NY, 14831, US

(21) Appl. No.: 10/664,484

(22) Filed: Sep. 19, 2003

(51) Int. Cl. C11D 1/00

(52) U.S. Cl. 510/170; 510/175

(57) ABSTRACT

The invention is directed to a chemical composition that can be used to clean, etch and dissolve single crystals of the Group IIA metal fluorides (the fluorides of magnesium, calcium, barium and strontium). The composition according to the invention is an aqueous solution of a mineral acid and a fluoride ion sequestering agent. The invention is further directed to a method of making Group IIA metal fluoride single crystals using seed crystals that has been cleaned and/or etched using the composition of the invention.

### FIELD OF THE INVENTION

The invention is directed to a chemical composition that can be used to make single crystals of the Group IIA metal fluorides suitable for use on optical lithographic systems operating below 250 nm, and further to etch, clean and dissolve such single crystals for analytical and other purposes.

### BACKGROUND OF THE INVENTION

The burden of the demands for improved performance of computers falls on the lithographic process used to fabricate the integrated circuit chips. Lithography involves irradiating a mask and focusing the pattern of this mask through an optical microlithography system onto a wafer coated with a photoresist. The pattern on the mask is thereby transferred onto the wafer. Decreasing the line-widths of the features on a given wafer brings about advances in performance. The enhanced resolution required to achieve finer line-widths is enabled by decreasing the wavelength of the illumination source. As a result, the energies used in lithographic patterning are moving deeper into the UV region. Consequently, optical components capable of reliable performance at these short optical microlithography wavelengths are required.

Few materials are known that have a high transmittance at wavelengths below 200 nm, for example, at 193 nm and 157 nm, and also do not deteriorate under intense laser exposure. Fluoride crystals such as magnesium fluoride, calcium fluoride and barium fluoride are potential materials with high transmittance at wavelengths<200 nm. Projection optical photolithography systems and<200 nm excimer laser systems that utilize vacuum ultraviolet wavelengths of light at and below 200 nm provide desirable benefits in terms of achieving smaller feature dimensions. Excimer lasers and microlithography systems that utilize vacuum ultraviolet wavelengths in the 157 nm wavelength region have the potential of improving integrated circuits and their manufacture.

The commercial use and adoption of 193 nm and below vacuum ultraviolet wavelengths (“VUV”) such as 157 nm has been hindered by the transmission nature of such deep ultraviolet wavelengths in the 157 nm region through optical materials. Such slow progression by the semiconductor industry of the use of VUV light in the below 175 nm such as the 157 nm region has been also due to the lack of the ability to economically manufacture high quality blanks of optically transmissive materials suitable for microlithography optical elements for use with laser operating below 200 nm. Consequently in order to utilize deep ultraviolet photolithography in the VUV region to manufacture integrated circuits using, for example, fluorine excimer lasers, there is a need for below 200 nm wavelength transmitting optical fluoride crystals such as those made from the fluorides of magnesium, calcium and barium. Such quality crystals must be of high quality, possessing few defects and having beneficial optical and highly qualified properties including low contaminant levels, and these crystals must be able to be manufactured, tested, evaluated, measured and qualified for use economically.

One problem presented by single crystals of the Group IIA metal fluorides such as those of magnesium, calcium and barium is that these crystalline materials are often difficult to chemically clean, etch or dissolve. For example it is difficult to clean or etch the surfaces of seed crystals used for growing additional crystals or to dissolve the crystals for the purpose of providing for the bulk analysis of trace impurities that can have a deleterious effect on the optical transmission properties of optical elements made from such crystals. For example, according to the Handbook of Physics and Chemistry calcium fluoride has a solubility of approximately 0.0017 g/100 mL at 26° C. Calcium fluoride is stable at ambient temperatures, is slowly hydrolyzed by moist air at 1200° C., is not attacked by alkalis and reactive fluorine compounds, but will dissolve or be decomposed in hot, high boiling acid such as concentrated sulfuric acid (Kirk-Othmer, Encyclopedia Of Chemical Technology, 4^{th} Ed (New York: John Wiley & Sons, 1994), page 324). Magnesium fluoride crystals are even more intractable having a much lower solubility than calcium fluoride. While the solubility data from several references are not consistent, e.g. 0.076 g/100 mL from the CRC Handbook of Physics and Chemistry, it is believed that the actual solubility is much lower than 0.0013 g/100 mL. The reaction of magnesium fluoride with hot sulfuric acid is so sluggish that magnesium fluoride is not used for manufacturing fluorine (F₂) as is fluorospar (natural CaF). Barium fluoride is the most “reactable” of the three, but even this material when in single crystal form is slow or difficult to clean, etch or dissolve in mineral acids.

Very briefly, in order to understand why it is difficult to clean, etch or dissolve the Group IIA metal fluoride one must understand the nature of ionic crystals and the factors that influence solid-liquid reactions. Generally, ionic substances such as the Group IIA metal fluorides are only slightly soluble in most common solvents, except for those solvents that are quite polar. The strong attractive forces between the ions must be overcome and this can be accomplished only if the attractive forces between ions and the solvent molecules are at least comparable to the lattice energy of the crystal. If this criterion is not met, then the crystal will not dissolve or be etched. In addition, structural factors such as the crystal face exposed and lattice defects influence solid-liquid interfacial reactions.

The effects of lattice defects are evident from frequently observed preferential chemical attack by solvents at localized spots on the surface of crystals, for example, at scratches, grain boundaries or the emergence points of dislocations. In etching, as in decomposition, some sites are often particularly suited for reactions. (It should also be mentioned that preferential etching can also be caused by liquids that dissolve the solid physically). Dislocations, which are non-equilibrium defects, are particularly important. In the case of ionic materials, since the ions near the dislocations are not in their lowest energy positions, the region near the dislocation is in a higher energy state than in a perfect crystal. Single crystals of many metals and non metals have been formed and it has been found that annealed metal crystals contain approximately 10⁶ dislocations lines/cm². However, this number is generally less in ionic crystals. The more perfect the crystal, the lesser the number of dislocations that will be present.

For use in optical lithography, the goal has been to grow crystals that are as nearly perfect as possible in order to avoid lithographically detrimental problems such as beam birefringence and dispersion due to defects in the crystals. These detriments need to be minimized so features being lithographed on a substrate can be as sharp and small as possible. As one can understand from the discussion in the previous paragraph, the more perfect the crystal is, the more difficult it will be to clean, etch or dissolve the crystal.

The present invention overcomes problems in the prior art and provides a mean for economically providing high quality Group IIA metal fluoride crystals, blanks and optical elements made therefrom, by providing a chemical composition that can be used to prepare seed crystals suitable for growing single crystals, cleaning the surface of single crystals and dissolving single crystals to facilitate their chemical analysis.

### SUMMARY OF THE INVENTION

The invention is directed to a chemical composition that can be used to clean, etch and dissolve single crystals of the Group IIA metal fluorides (the fluorides of magnesium, calcium, barium and strontium). The composition according to the invention is an aqueous solution of a mineral acid and a fluoride ion sequestering agent.

The invention is also directed to a method of preparing single crystals of the Group IIA metal fluorides wherein a seed crystal used in the preparation of the single crystals has been chemically cleaned or etched by an aqueous solution of a mineral acid and a fluoride ion sequestering agent prior to use. The crystals grown by the inventive process are suitable for use in lithographic processes using electromagnetic radiation below a wavelength of 250 nm.

In one aspect the invention is directed to a method of making a single crystal of an alkaline earth metal fluoride suitable for use in making<200 nm optical elements, the method comprising the steps of:

providing an aqueous cleaning/etching composition comprised of a mineral acid and a fluoride ion sequestering agent;

providing an alkaline earth metal fluoride seed crystal;

cleaning/etching the fluoride seed crystal with the cleaning/etching solution and removing boron residues by washing with a dilute hydrofluoric acid solution;

providing a crucible suitable for growing metal fluoride crystals, the crucible having a reservoir at its bottom for receiving the seed crystal;

inserting the seed crystal into the reservoir wherein the cleaned and etched crystal is oriented along a selected orientation;

charging the crucible with a metal fluoride feed stock;

placing the charged crucible into a furnace suitable for growing metal fluoride crystals and heating the crucible containing the feedstock to melt the feedstock and the top part of the seed crystal; and

slowly cooling the melt so as to grow an oriented alkaline earth metal fluoride crystal having an<200 nm internal transmission of at least 90%/cm.

A method of dissolving a single crystal of an alkaline earth metal fluoride or fragments thereof, the method comprising the steps of:

providing an aqueous alkaline earth metal fluoride dissolving solution comprised of a mineral acid and a fluoride ion sequestering agent;

providing an alkaline earth metal fluoride crystal or fragments thereof; and

dissolving said metal fluoride crystal or fragments thereof in said dissolving solution.

### DETAILED DESCRIPTION OF THE INVENTION

As used herein the term “metal fluorides” refers to fluorides of the Group IIA metals magnesium, calcium, barium and strontium.

The invention is directed to a chemical composition that can be used to clean, etch and dissolve single crystals of the Group IIA metal fluorides. Cleaning and etching the single crystal provides surfaces that are suitable for further processing to prepare optical blanks and/or elements (that is, components like lenses, prisms, and similar elements known in the art) suitable for below 200 nm lithography, or to provide seed crystal that can be used to prepare additional single crystals of the Group IIA metal fluorides. Dissolution of such crystals results in a solution suitable for chemical analysis of trace impurities present in the crystal.

Although flux fusion decomposition methods can be used to dissolve the Group IIA metal fluoride crystals, such methods introduce excess salts and contaminants into the resulting solution. These contaminants will obscure the analysis for critical trace elements, for example metal ions, whose presence is detrimental to the lithographic process. As an alternative to such methods, it has been found that minerals acids, in combination with a substance that can sequester fluoride ion (a “sequestering agent”), can be used to clean, etch and dissolve Group IIA fluoride single crystals without the introduction of detrimental substances. In accordance with the invention, mineral acids are available in high purity; do not introduce excess salts which is of grave concern in some trace element detection techniques; and the conditions for dissolving, cleaning or etching can be easily controlled and controlled to meet specific dissolution targets. For example, the concentration of the mineral acid and fluoride ion sequestering agent, and the temperature at which the composition is used can be easily controlled. In addition, by using mineral acids as the basis for the composition of the invention, the process of cleaning, etching or dissolving a metal fluoride crystal can be easily scaled to meet any sample size and/or weight conditions.

The dissolving of the Group IIA metal fluorides, particularly magnesium and calcium fluorides (and especially magnesium fluoride) in mineral acids alone is generally ineffective due to the fact that the solubility product for the Group IIA alkaline earth fluorides is very low. In order to alter this equilibrium condition it is necessary to introduce a complexing agent that will sequester fluoride anions as the crystal dissolves. As a result of sequestering the fluoride anions, the metal cations remain in solution, free from recombination and precipitation as an insoluble fluoride salt. One such sequestering agent is boron which is conveniently available in high purity and convenient forms such as boric acid, H₃BO₃. Additional sequestering agents include hypophorphorus acid (H₃PO₂, commercially available as 50 wt. % in H₂O), metaphosphoric acid [(HPO₃)ₙ (commercially available as 33-37 wt % HPO₃ in H₂O] and other, non-metallic agents known in the art to sequester fluoride ion.

Several aqueous mineral acids can be used in accordance with the invention. Examples of such mineral acids, without limitation, include nitric acid, hydrochloric acid, perchloric acid and hypochlorous acid. The preferred mineral acid is concentrated nitric acid. Sub-boiling distilled ultra pure nitric acid is commercially available.

The composition of the invention comprises approximately 1 part by volume of concentrated aqueous mineral acid to 0.5-4.0 parts by volume of an aqueous solution of a fluoride ion sequestering agent wherein the fluoride ion sequestering agent is present in the solution at a concentration in the range of 3-7% wt./vol. (“w/v”). The diluted concentration of the fluoride ion sequestering agent will be in the range of 1% w/v to —approximately 5.6% w/v. For example, using H₃BO₃ as the sequestering agent, an exemplary composition of the invention would comprise 8 parts by volume concentrated nitric acid to 10 parts by volume of an aqueous solution of 4-6% w/v H₃BO₃ (approximately 8,000 ppm by weight B). The resulting composition would have a boric acid concentration in the range of 2.2-3.3% w/v. Another exemplary composition using concentrated perchloric acid (60-70% wt. %) would comprise 1 part by volume concentrated perchloric acid and approximately 1 part by volume of 6% (w/v) H₃BO₃ or approximately 0.5 parts by volume of metaphosphoric acid. The preferred compositions are the nitric acid/H₃BO₃ compositions. The solubility of H₃BO₃ is 6.35% w/v at 30° C.

The time and temperature required for cleaning, etching and/or dissolving the metal fluoride material will vary, and the variation depends on the metal fluoride material being used and the goal sought (cleaning, etching, or dissolving). In addition, the physical size of the material undergoing treatment will contribute to the variation. Generally the conditions for cleaning, etching and dissolving a metal fluoride material will be in the range of 1 hour to several (2-5) days and the temperature will be in the range of 18-250° C., depending on the specific fluoride material and its physical form [complete disk, optical element (or fragments thereof) or seed crystal]. Cleaning and etching will usually be done on complete disks or optical elements. Dissolving can be accomplished using complete disks or optical elements, or fragments thereof, but is most easily done on a finely ground powder ˜100 microns.

The conditions required to dissolve magnesium fluoride are more severe than those used for calcium fluoride or barium fluoride. As a example of variations involved, for dissolving magnesium fluoride the temperatures required will be in the range of 125-250° C. and the time will be in the range of 4 hours (cleaning) to several (2-5) days (dissolving). If the magnesium fluoride material is in the form of a single disk or element, the time and temperature for dissolving will be at the top part of the range. If the disk is ground to a fine powder ˜100 microns, both the time and the temperature required may be reduced, although it is preferred to keep the temperature at the upper range (175-250° C.) and allow the time to decrease (approximately 1-2 days). In addition, when dissolution is the objective, it is preferred that the reactions be carried out in inert, sealable vessels, for example, vessels made of an inert material or lined with an inert such as TEFLON® [for example, TEFLON PFA 9perfluoroalkoxy0, TEFLON PTFE (polytetrafluoroethylene) and HOSTALON® (a second generation PTFE)], polyethylene, polypropylene or other materials that are inert to the compositions of the invention and can withstand the temperature applied. For example, a TEFLON PTFE lined Parr bomb that will withstand a temperature of 260° C. and a high pressure of 1500 psi, or a high temperature, high pressure microwave vessel made of TEFLON PTFE (up to 260° C.) or HOSTALON TFM (up to 300° C.). (The vessels may be sealed; consequently the pressure will rise during the process due to heating. It is advisable to have a pressure relief valve attached to the vessel in order to prevent the vessel from exceeding its operating limitations. In addition, it is advisable to place the vessel in a location where the contents can be contained in the event of rupture.) When the purpose is to clean a magnesium fluoride disk, element or a seed crystal that will be used to grow disks of magnesium fluoride, the temperature will be at the lower end of the range (125-175° C.) and the time will also be in the lower end of the range (for example, 1-48 hours). When the purpose is to etch a magnesium fluoride disk, element or seed crystal the temperature will be in the middle to upper part of the range (for example, 150-225° C.) and the time will depend on how much material must be etched from the disk, element or crystal. We have found that when cleaning or etching a magnesium fluoride seed crystal using the composition of 8 parts of nitric acid with 10 parts of 4.6% w/v H₃BO₃ (approximately 8000 ppm by weight B) at a temperature of 150° C., the etching or cleaning rate is approximately 10 mg/cm² per 24 hour. The above seed crystal has its cylindrical axis at the<001>direction, and has a diameter of 0.93 cm and a length of 3.3 cm. When cleaning or etching an optical disk with the same crystal orientation but with a diameter of 6 cm and a depth of 0.4 cm, however, the etch rate is closer to 12 mg/cm² per 24 hour at 100° C. Crystals usually have a preferred etching rate along different crystallographic orientations. For a magnesium fluoride disk, optical element or seed crystal, the etching rate is much faster along the<011>direction than the other directions. Fine powders (<100 micron) will dissolve at a rate of 25 mg per 24 hour at 100° C.

When the material is calcium fluoride the conditions for cleaning, etching and dissolving are less severe. For example, cleaning and or etching can be carried out at a temperature in the range 75-150° C. for a time in the range of 0.5-24 hours. Dissolution can be carried out at temperatures in the range of 75-200° C. for a time in the range of 1-48 hours (depending on the size of the disk or fragments being dissolved).

When the material is barium fluoride the cleaning or etching can be carried out in a temperature range of 18-100° C., preferably in the range of 30-100° C. for a time in the range of 10 minutes to 4 hours. Dissolution can be carried out at a temperature in the range of 50-200° C., preferably in the range of 50-150° C. for a time in the range of 1-24 hours.

The composition of the invention is useful for the preparation of metal fluoride crystals. For example, a magnesium, barium, or calcium fluoride seed crystal having the desired orientation can be prepared by cutting a previously grown crystal. The crystal is cleaned and/or etched using a mineral acid and a fluoride sequestering agent in accordance with the invention. The seed crystal is then placed a crucible having at its bottom a reservoir for receiving the seed crystal. The crucible is then charged with an appropriate metal fluoride feedstock (e.g., MgF₂, CaF₂ BaF₂) and the crucible is placed in a furnace suitable for growing metal fluoride crystals. The metal fluoride crystal is then grown in accordance with methods known in the art, for example, the Bridgeman-Stockbarger method, U.S. Pat. Nos. 6,485,562, 6,402,840, 6,364,946, 4,521,272 and 4,404,172; and other methods known in the art.

As an example of a method utilizing the inventive composition includes the steps of providing a cleaning/etching solution comprised of a mineral acid and a fluoride ion sequestering agent; providing an alkaline earth metal fluoride seed crystal; etching the fluoride seed crystal with the cleaning/etching solution; providing a crucible suitable for growing metal fluoride crystals, the crucible having a reservoir at its bottom for receiving the seed crystal; inserting the seed crystal into the reservoir wherein the cleaned and etched crystal is oriented along a selected orientation; charging the crucible with a metal fluoride feed stock; placing the charged crucible into a furnace suitable for growing metal fluoride crystals and heating the crucible containing the feedstock to melt the feedstock and the top part of the seed crystal; and slowing cooling the melt so as to grow an oriented alkaline earth metal fluoride crystal having an<200 nm internal transmission of at least 90%/cm. For example, the crystal grown in accord with the foregoing method has a 193 nm internal transmission greater than 95%/cm and a 157 nm internal transmission greater than 90%/cm.

The foregoing examples of specific compositions, processes, articles and/or apparatus employed in the practice of the present invention are, of course, intended to be illustrative rather than limiting, and it will be apparent that numerous variations and modifications of these specific embodiments may be practiced within the scope of the appended claims.

1. A composition suitable for cleaning, etching and dissolving alkaline earth metal fluoride crystals and optical elements made therefrom, said composition comprising a mineral acid and a fluoride ion sequestering agent.

2. The composition according to claims 1, wherein the mineral acid is selected from the group consisting of concentrated nitric acid, concentrated perchloric acid and concentrated hydrochloric acid.

3. The composition according to claim 1 wherein the fluoride ion sequestering agent is selected from the group consisting of boric acid, hypophosphorus acid and metaphosphoric acid.

4. The composition according to claim 1, wherein the mineral acid is concentrated nitric acid and the sequestering agent is boric acid.

5. The composition according to claim 1, wherein the concentration of the fluoride ion sequestering agent is in the range of 1-5.6% w/v.

6. The composition according to claim 4, wherein the concentration of the fluoride ion sequestering agent is in the range of 1-5.6% w/v.

7. A method of making a single crystal of an alkaline earth metal fluoride suitable for use in making <200 nm optical elements, the method comprising the steps of:
providing an aqueous cleaning/etching composition comprised of a mineral acid and a fluoride ion sequestering agent;
providing an alkaline earth metal fluoride seed crystal;
cleaning/etching the fluoride seed crystal with the cleaning/etching solution and removing boron residues by washing with a dilute hydrofluoric acid solution;
providing a crucible suitable for growing metal fluoride crystals, the crucible having a reservoir at its bottom for receiving the seed crystal;
inserting the seed crystal into the reservoir wherein the cleaned and etched crystal is oriented along a selected orientation;
charging the crucible with a metal fluoride feed stock;
placing the charged crucible into a furnace suitable for growing metal fluoride crystals and heating the crucible containing the feedstock to melt the feedstock and the top part of the seed crystal; and
slowing cooling the melt so as to grow an oriented alkaline earth metal fluoride crystal having an<200 nm internal transmission of at least 90%/cm.

8. The method according to claim 7, wherein the cleaning/etching solution is comprised of:
(a) one part concentrated mineral acid and
(b) 0.5-7 parts a solution of a fluoride ion sequestering agent, wherein the sequestering agent is present in the solution at a concentration in the range of 3-7% wt./vol.

9. The method according to claim 8, wherein the sequestering agent is boric acid and the mineral acid is concentrated nitric acid.

10. The method according to claim 7, wherein the cleaning/etching is conducted at a temperature in the range of 30-175° C. for a time in the range of 30 minutes to 48 hours depending on the alkaline earth metal fluoride undergoing cleaning/etching, the temperature being greater and/or the time being longer in the order MgF₂>CaF₂>BaF₂.

11. A method of dissolving a single crystal of an alkaline earth metal fluoride or fragments thereof, the method comprising the steps of:
providing an aqueous alkaline earth metal fluoride dissolving solution comprised of a mineral acid and a fluoride ion sequestering agent;
providing an alkaline earth metal fluoride crystal or fragments thereof;
dissolving said metal fluoride crystal or fragments thereof in said dissolving composition.

12. The method according to claim 11, wherein the dissolving solution is comprised of:
(a) one part concentrated mineral acid and
(b) 0.5-7 parts a solution of a fluoride ion sequestering agent, wherein the sequestering agent is present in the solution at a concentration in the range of 3-7% wt./vol.

13. The method according to claim 8, wherein the sequestering agent is boric acid and the mineral acid is concentrated nitric acid.

14. The method according to claim 11, wherein the dissolving is conducted at a temperature in the range of 50-250° C. for a time in the range of 1 hour to 5 days depending on the alkaline earth metal fluoride undergoing cleaning/etching, the temperature being greater and/or the time being longer in the order MgF₂>CaF₂>BaF₂.
